(19) United States
(12) Patent Application Publication
(10) Pub. No.: US 2014/0017080 A1
(43) Pub. Date: Jan. 16, 2014

(54) WIND TURBINE, WIND FARM AND METHOD FOR GENERATING POWER

(71) Applicant: e.n.o. Energy Systems GmbH, Rostock (DE)

(72) Inventors: Karsten Porm, Kroepelin/Diedrichshagen (DE); Tony Maass, Hanshagen (DE); Stefan Bockholt, Kuehlungsborn (DE); Martin Hoerenz, Rostock (DE)

(21) Appl. No.: 13/939,332

(22) Filed: Jul. 11, 2013

(30) Foreign Application Priority Data
Jul. 13, 2012 (DE) 102012013896.2

(51) Int. Cl. F03D 7/02

(52) U.S. Cl. CPC F03D 7/02
USPC 416/1; 416/241 R

(57) ABSTRACT

Exemplary embodiments concern a wind turbine having a horizontal axis and at least one rotor blade, which in regular operation at a wind speed of more than 4 m/s always comprises a static thrust coefficient c_{S} of less than 0.8. The wind turbine is designed for a design turbulence intensity, corresponding to the definition of the characteristic value of turbulence intensity I₁₅ at 15 m/s according to IEC 61400-1, Edition 2, of more than 18% and less than 26%. It may thus be possible to achieve an improved utilisation of space.

### CROSS REFERENCE TO RELATED APPLICATIONS

The present application claims the priority of the German patent application entitled “Windenergieanlage”, filed on 13 Jul. 2012 with application number 10 2012 013 896.2. The content of the above-mentioned application is incorporated herein by reference.

### TECHNICAL FIELD

Exemplary embodiments concern a wind turbine as can be arranged for example in wind farms, a wind farm, and a method for generating power.

### BACKGROUND

Due to different challenges and problems when recovering power by means of conventional technologies, there is an increasing interest in renewable or ecologically more compatible sources of power. Besides solar technology, the use of wind turbines for example thus constitutes such an environmentally more compatible technology for supplying power.

In this case, wind turbines are typically erected and operated at locations where there is a basic suitability for the operation of such an installation, and on the other hand where further basic conditions enable the erection and the operation. These basic conditions can be influenced for example by a cost associated with the removal of the generated power, costs for the operation, maintenance and servicing of corresponding wind turbines, but also the cost for the development of the area in question and the public acceptance of the wind turbines, to name just a few of the boundary conditions concerned. In this case, the wind turbines can be erected and operated for example on land (on-shore turbines), but also at sea (off-shore turbines).

There is thus a need to achieve an improved utilisation of space.

### SUMMARY

In accordance with an exemplary embodiment, a wind turbine having a horizontal axis and at least one rotor blade always comprises as a static thrust coefficient c_{S} in regular operation at a wind speed of more than 4 m/s a value less than c_{S}=0.8. It is also designed for a design turbulence intensity, corresponding to the definition of the characteristic value of turbulence intensity I₁₅ at 15 m/s according to IEC 61400-1, Edition 2, of more than 18% and less than 26%.

In accordance with an exemplary embodiment, a wind farm comprises a plurality of wind turbines, wherein at least one wind turbine comprises a horizontal axis and at least one rotor blade, wherein at least one wind turbine in regular operation at a wind speed of more than 4 m/s comprises a static thrust coefficient with a value less than 0.8 and is designed for a design turbulence intensity, corresponding to the definition of the characteristic value of turbulence intensity at 15 m/s according to IEC 61400-1, Edition 2, of more than 18% and less than 26%.

In accordance with an exemplary embodiment, a method for generating power comprises a generation of power by means of a wind turbine and a generation of power by means of at least one further wind turbine, wherein the at least one further wind turbine is arranged in a wake of the wind turbine at a reduced, dimensionless spacing based on the rotor diameter. The wind turbine comprises a horizontal axis and at least one rotor blade, wherein the wind turbine in regular operation at a wind speed of more than 4 m/s always has a static thrust coefficient c_{S} of less than c_{S}=0.8 and is designed for or comprises a design turbulence intensity, corresponding to the definition for the characteristic value of turbulence intensity I₁₅ at 15 m/s according to IEC 61400-1, Edition 2, of more than 18% and less than 26%.

Exemplary embodiments are thus based on the finding that a utilisation of space for turbine locations within a wind farm can thus be improved since the individual wind turbines can be constructed at shorter distances from one another.

### BRIEF DESCRIPTION OF THE FIGURES

Exemplary embodiments will be explained in greater detail hereinafter with reference to the accompanying figures.

FIG. 1 shows a schematic side view of a wind turbine according to an exemplary embodiment;

FIG. 2 shows a possible profile of a rotor blade of a wind turbine according to an exemplary embodiment;

FIG. 3 shows a schematic view of a wind farm according to an exemplary embodiment;

FIG. 4 shows a schematic view of a conventional wind farm; and

FIG. 5 shows a flow diagram of a method for generating power according to an exemplary embodiment.

### DETAILED DESCRIPTION

Some exemplary embodiments will now be described in greater detail with reference to the accompanying figures. In the figures, the thicknesses of lines, areas, layers and/or regions may be exaggerated for the sake of clarity.

In the following description of the accompanying figures, which merely show some exemplary embodiments, like reference signs may denote like or comparable components. Furthermore, all-encompassing reference signs can be used for components and objects that occur a number of times in one exemplary embodiment or in one drawing, but are described jointly with regard to one or more features. Components or objects that are described with like or all-encompassing reference signs may be designed identically, but where appropriate also differently, with regard to individual features, a number of features, or all features, for example their dimensions, unless otherwise evident explicitly or implicitly from the description.

Although exemplary embodiments can be modified and altered in different ways, exemplary embodiments are illustrated in the form of examples in the figures and will be described herein in detail. It should be clarified however that there is no intention to limit exemplary embodiments to the respective disclosed forms, but that exemplary embodiments rather cover all functional and/or structural modifications, equivalents and alternatives that lie within the scope of the invention. Like reference signs denote like or similar elements throughout the description of the figures.

As already described in the introduction, wind turbines are typically erected and operated at locations where there is a basic suitability for the operation of such an installation, that is to say for example where a sufficient wind strength prevails with appropriate frequency, although on the other hand further basic conditions also enable the erection and the operation of such a wind turbine. The different influences on these basic conditions can be manifold. In this case, the wind turbines can be erected and operated on land (on-shore turbines), but also at sea (off-shore turbines), for example.

There is thus a need to achieve a more improved utilisation of space. Conventionally, another path was taken.

A wind turbine type is largely designed within the scope of standard IEC 61400. In this case, a turbine design is selected that, from the wind conditions defined in the standard, allows the greatest possible output of power at the lowest possible costs. In order to achieve this, a maximum aerodynamic efficiency of the turbine rotor is to be implemented alongside low material use. The wind turbine rotor is conventionally designed such that, by selection of a suitable blade geometry, a maximum power coefficient is achieved with optimal angle of attack.

Based on the individual rotor blade profile, the lift/drag ratio in particular is a measure for the efficiency. This is characterised as the ratio of lifting force to drag of the rotor blade. The greater this ratio, the more efficient is the profile. The maximum lift/drag ratio characterises the design point of a rotor blade of a wind turbine and determines the optimal angle of attack. Here, a maximum lift/drag ratio greater than 150 is sought.

In order to achieve such a value, profile geometries with maximum lift coefficient c_{A} and minimum drag coefficient c_{W} are selected. In this case, lift coefficients of c_{A}>1.0, and often even c_{A}>1.5, are achieved and selected in the design point. The increase of the lift coefficient c_{A} is generally also accompanied however by an increase of the drag coefficient c_{W}.

The operating parameters of a turbine rotor, such as nominal speed and tip speed ratio, are predominantly selected in accordance with economical and emission-based aspects.

The nominal speed of the rotor is characterised as the ratio of the blade tip speed v_{TIP} to rotor periphery. The nominal speed here is selected to be as large as possible in order to reduce the rotor torque to be transmitted. An increase of the nominal speed is opposed however by restrictions concerning sound emissions. As is known, the sound emission of a wind turbine increases with the rotor blade tip speed. As a compromise between acceptable sound emissions and low rotor torque, blade tip speeds between 72 m/s and 80 m/s are conventionally generally selected. It is sometimes attempted to increase these values further by means of a special noise-optimised profiling at the rotor.

The design tip speed ratio of the turbine rotor is defined as the quotient from the blade tip speed vₜᵢₚ and the wind speed v_{wind} prevailing at the design point. The design tip speed ratio determined in accordance with the previously mentioned design criteria and the achievable speed range of the turbine is a key design parameter of a wind turbine.

The turbulence of the airflow induced by a wind turbine, said turbulence influencing the efficiency of the turbines in the wake, is determined above all by the thrust of the rotor. The magnitude of the turbulence is characterised by the dynamic pressure and the rotor size and also by the thrust coefficient. Since the dynamic pressure caused by the air density and the wind speed present and also the rotor diameter for a given turbine type cannot be changed, the induced turbulence can only be influenced by means of the parameters determining the thrust coefficients, profiling and operating conditions. The thrust coefficient of conventional turbines in part-load operation reaches a value of more than 0.8, and at very low wind speeds a value of 1.0 is often achieved or exceeded.

The assumed loads for wind turbines are calculated in accordance with specifications for specific wind classes stipulated in standards. Here, IEC 61400 is applied most frequently. Besides the design wind speeds, values I₁₅ (Edition 2) characteristic for the turbulence intensity and expected values I_{ref} (Edition 3) for the various wind categories are defined in IEC 61400-1, in each case based on a wind speed of 15 m/s.

In accordance with standard IEC 61400-1 (Edition 2), design turbulence intensities of 18% and 16% are defined for turbulence categories A and B respectively. In accordance with standard IEC 61400-1 (Edition 3), design turbulence intensities of 16%, 14% and 12% are defined for turbulence categories A, B and C respectively.

In DE 200 23 134 U1 and DE 199 48 196 A1, a wind farm formed from at least two wind turbines is described, wherein the amount of power delivered by the wind turbines is limited to a maximum possible network supply value lower than the maximum possible value of the power to be delivered. The maximum possible supply value is determined by the receiving capacity of the network. The power of the wind turbines initially exposed to the wind within the wind farm is less limited than that of wind turbines arranged behind the aforementioned wind turbines in the wind direction (wakes). As soon as the wind speeds are high enough to generate the power limit, the wind farm control engages and controls individual turbines or all turbines when the total maximum power is exceeded, in such a way that this power limit is always observed. The wind farm power control in this case controls the individual turbines such that the maximum possible power output is set.

DE 10 2008 052 858 A1 describes a profile of a rotor blade of a wind turbine designed for maximum lift coefficient, but does not discuss a possible optimisation of the lift/drag ratio or the turbulence behaviour. With this profile, the profile mean line runs at least in portions below the chord in the direction of the driving face, and the profile comprises a relative profile thickness of more than 45% with a position of maximum thickness of less than 50%, wherein a lift coefficient (c_{A}) of greater than 0.9, in particular greater than 1.4, is achieved in turbulent flow.

A method for controlling wind turbines in order to reduce wake loads for the purpose of increasing the output of a wind farm is known from EP 2 063 108 A2. A control system for a wind farm power generation installation is described, wherein, in the wind farm, at least one wind turbine is arranged in the wind direction and at least one wind turbine is arranged in the wake and a central processing and control unit is connected to these turbines, wherein the central processing and control unit receives the data from at least the turbine arranged to the front, establishes the state of the at least one turbine arranged in the wake, and, if necessary, selectively controls the turbine arranged to the front in order to increase the power yields of the entire wind farm. Here, each wind turbine has a local controller.

A further method for reducing wake loads of wind turbines by controlling the angle of inclination of the rotor blades and the rotational speed of individual turbines is known from DE 10 2010 026 244 A1, wherein, in a wind turbine, output potential is omitted if further wind turbines follow in the wind direction. In particular, output losses in the following wind turbine caused by shadowing effects or material loads due to turbulences are to be limited by increasing the rotor speed at the first turbine or by adjusting the rotor blades so that these are contacted less heavily by the wind. The turbine controller is thus programmed such that the turbine, with wind in the direction of a following turbine, reduces its own power in favour of the following turbine, whereas with other wind directions a purely turbine-based, optimised control is implemented.

Both methods exclusively target the power optimisation of existing configurations.

A method for designing wind farm configurations for the reduction of wake effects is known from EP 2 246 563 A2. The method comprises the step of determining the wind conditions at one location by modelling the wind state with the wake effects at the respective locations as a result of cumulative effects from the placement of the wind turbines and the selection of the wind turbine configuration. The actual wind conditions are therefore discussed, wherein a selection of the turbine configuration including a selection of the hub height so as to reduce the losses of the individual turbines in accordance with the actual wind conditions is made. In this case, there is no mention of the design, the operation, and the control of individual turbines, but instead the modelling of the anticipated power output of a wind farm at a selected location due to the wind conditions actually prevailing there is discussed.

A method for increasing the output of power over area of a wind farm is known from DE 10 2011 051 174 A1. In this case, the directions of rotation of the individual turbines are adapted with substantially horizontal axes of rotation of the rotors in order to increase power by reducing the degree of turbulence of wake flows, wherein the individual turbines in the wind farm or sea-current farm comprise rotors having different directions of rotation.

EP 1 790 851 A2 and US 2007/0124 025 A1 describe a method for controlling wind turbines in a wind farm, wherein data from wind turbines to the front and in the wake is captured, compared, and used to control the wind turbines to the front in order to reduce the fatigue loads of the turbines in the wake by controlling the speed of the turbines arranged to the front.

In US 2011/0046 803 A1 and US 2010/0078 940 A1, the control of a wind farm comprising a plurality of wind turbines, of which the rotational speed is variable, is described. In US 2010/0078 940 A1, the angle of attack is also controlled in addition to the rotational speed of the wind turbines. Aerographs are arranged in the vicinity of the wind turbines in order to measure the directions and forces of the wind at the locations of the wind turbines. The rotational speed and/or the angle of attack of the wind turbines is/are controlled via control devices on the wind turbines, wherein a central controller keeps the power output of the wind farm constant for a predefined period of time and, via the control devices on the wind turbines, controls the rotational speeds and/or the angle of attack of the wind turbines in accordance with the controlled power output.

In WO 2004/111 446 A1, a turbine operation is described that consists at least of a first turbine and at least of a second turbine, wherein the turbines are driven by the power of a flowing fluid. If the second turbine is at its nominal power, the axial induction at the first turbine is lowered with respect to the second turbine in order to thus reduce the turbulences at the second turbine on the lee side.

In CA 2 529 336 A1 and also in JP 2002-027 679 A, a method for operating a wind farm comprising a multiplicity of wind turbines is described, wherein the method comprises the monitoring of the wind speed at the wind turbines, the transmission of the signals to a control system, and also the monitoring and control of the change to the power of the wind farm via the coordination of the operating states of the wind turbines.

A controller and a control method for a wind farm comprising a multiplicity of wind turbines for generating electrical power from wind are disclosed in JP 2002-349 413 A, wherein the control devices of the wind turbines communicate with one another via a communication unit. The network supply power of the wind farm is set to a target value, at the value of which the control device controls the wind turbine in coordination with the network supply power.

JP 2001-234 845 A discloses a controller for a wind farm comprising a multiplicity of wind turbines, wherein the wind farm controller suppresses wind turbines having large power fluctuations and thus reduces the overall power fluctuations of the wind farm.

The increasing development of wind power leads to a shortage of the areas available for the erection of wind turbines, such that a concentrated use of this scarce resource or “area” is necessary. Wind turbines have previously been designed and operated however such that they are considered as individual installations and separately generate a maximum output at minimised unit cost. This design approach and method of operation is not optimal however for the function and the output of these turbines in a wind farm setting. The theoretically possible output yield of such a wind farm is not utilised optimally.

The selection of the operating parameter of the nominal rotor speed as a compromise between minimal rotor torque to be transmitted and maximum permissible blade tip speed in particular leads in the rated load range to rotor speeds that are to be considered as unfavourable in terms of turbulence. Equally, the selection of a high tip speed ratio, in particular in the part-load range, leads to unfavourable rotor speeds. Both of these are in turn unfavourable for the arrangement of turbines in wind farm configurations, since, with rising wake turbulence, the alternating loads on following machines are increased unfavourably.

The profile of a rotor blade of a wind turbine is also generally designed for a maximum lift/drag ratio. With such a profile design, an increase in drag is often entailed however and opposes an improved turbulence behaviour. Furthermore, it follows from such a profile selection that, even with small deviations of the angle of attack from the design point as a result of an additional increase of the drag coefficient, considerably reduced lift/drag ratios and therefore a renewed worsening of the turbulence behaviour are to be observed.

With a reduced lift/drag ratio, the efficiency of a wind turbine in turbulent wind additionally decreases, since, in a heavily turbulent flow, rapidly changing wind speeds (quails) caused by the inertia of the controller and system lead to an operation that does not correspond to the parameters of the design point.

Furthermore, the conventional described guidelines relating to the load design lead to machine designs that are not optimal for the maximum utilisation of space in a wind farm. The reason for this is that wind turbine types have a low design turbulence intensity for cost reasons.

A low design turbulence intensity is conventionally likewise generally accompanied by a relatively high drag, which in turn leads to a worsened turbulence behaviour. This is manifested in a high thrust coefficient and associated high wake turbulences of the rotor. The efficiency of a turbine in the wake thereof therefore reduces. Relatively large distances between the machines are therefore necessary in the wind farm setting. In particular, machines designed in such a way are adapted only insufficiently to locations having high ambient turbulence, for example forest locations, and are also insufficient for filling gaps in existing wind farms. This aspect is also disadvantageous for the efficiency of a wind turbine in a wind farm configuration.

The challenge is to develop a wind turbine for wind farms, in which the individual turbines are to be designed and operated aerodynamically and mechanically in such a way that a maximum utilisation of space in the wind farm setting is generated by a maximum density of turbines without negatively influencing the service life, of the individual machines. The core of exemplary embodiments here is the focusing on the operation of turbines in a wind farm setting in a manner in which the utilisation of the space is optimised by reducing the wake interferences by means of special rotor profiles and adapted operating parameters with simultaneously increased mechanical robustness of the individual machines with respect to turbulences induced by the wind farm and by the surrounding environment.

The challenge is overcome by a wind turbine according to an exemplary embodiment having a horizontal axis and at least one rotor blade, such that the wind turbine in the entire operating range does not exceed a static thrust coefficient of c_{S}=0.8, provided the wind speed is no more than 4 m/s.

In addition, the wind turbine is designed such that the requirements with regard to a design turbulence intensity of I₁₅=18% according to IEC 61400-1, Edition 2 (turbulence category A) and with regard to a design turbulence intensity of I_{ref}=16% according to IEC 61400-1, Edition 3, (turbulence category A) are exceeded.

The rotor blade profiles of the wind turbine, in the outer region in the design point of the wind turbine, which is characterised by a maximum lift/drag ratio, with a Reynolds number of 5 million, comprise a lift coefficient of c_{A}<1.3 and a drag coefficient of c_{W}<0.01. Furthermore, this profile comprises an angle of attack range of more than 5°, in which the drag coefficient does not exceed the value of the minimum drag coefficient of c_{W}≦0.007 by 50%.

In addition, the wind turbine is designed such that the design tip speed ratio is greater than 6.5, but does not exceed a value of 8.5 and/or the blade tip speed likewise does not exceed a value of 71 m/s in the entire operating range.

In a further advantageous exemplary embodiment, the wind turbine is arranged in a wind farm comprising at least two turbines, such that a reduction of the dimensionless spacing based on the rotor diameter compared to conventional turbines is thus achieved, whereby the utilisation of space of the wind farm improves.

In accordance with an exemplary embodiment, a wind turbine having a horizontal axis and at least one rotor blade thus always comprises as a static thrust coefficient c_{S} in regular operation at a wind speed of more than 4 m/s a value less than c_{S}=0.8. It is also designed for a design turbulence intensity, corresponding to the definition of the characteristic value of turbulence intensity I₁₅ at 15 m/s according to IEC 61400-1, Edition 2, of more than 18% and less than 26%.

Optionally, in a wind turbine according to an exemplary embodiment, the rotor profile of the rotor blade of the wind turbine at a design point, characterised by a maximum lift/drag ratio, in an outer region of the rotor blade may not exceed a lift coefficient of c_{A}=1.3 and a drag coefficient of c_{W}=0.01. Here, this profile may comprise an angle of attack range of more than 5°, in which the drag coefficient does not exceed the value of the minimum drag coefficient of c_{W}≦0.007 by 50%. In addition or alternatively, a blade tip speed of 71.5 m/s may not be exceeded in an entire operating range. Likewise additionally or alternatively, the design tip speed ratio may be at least 6.5, but less than 8.5.

In this case, the design point is the point at which the maximum lift/drag ratio is present, that is to say the maximum ratio of lifting force to drag of the rotor blade. The design wind speed can be defined here for example such that it is the wind speed at which a power coefficient is maximum. The design tip speed ratio, which specifies the ratio of the tip speed of the rotor blade (blade tip speed) to wind speed, can also be considered the design point accordingly, for example.

The thrust coefficient c_{S} is also referred to as the c_{T} value (thrust). The lift coefficient c_{A} is also referred to as the c_{L} value (lift), and the drag coefficient c_{W} is also referred to as the c_{D} value (drag). In other words, the symbol c_{T} is also used for the symbol c_{S}, the symbol C_{L} is also used for the symbol c_{A}, and the symbols c_{D} is also used for the symbol c_{W}.

In addition or alternatively, in a wind turbine according to an exemplary embodiment, the at least one rotor blade, in an outer region with an angle of incidence of 0°, may comprise a drag coefficient of c_{W}=0.005 and a lift coefficient of c_{A}=0.5, wherein, in a clean state, a maximum lift/drag ratio E of more than 150 can be achieved. It may thus also be possible, where appropriate, to reduce a mutual interference of wind turbines in a wind farm. In addition or alternatively, an efficiency of an individual wind turbine may thus also be increased, where appropriate.

Here, the outer region of the rotor blade may be a region of the rotor blade that, starting from the blade tip, comprises at least ⅙, at most ⅓, of the entire rotor blade length.

In addition or alternatively, a wind turbine according to an exemplary embodiment can be designed for example such that it comprises a tip speed ratio of 8, a maximum blade tip speed of 71 m/s, and a thrust coefficient c_{S} of 0.752. Optionally, such a wind turbine in accordance with an exemplary embodiment may comprise a rotor diameter of 115 m and a design wind speed of 8.75 m/s. Optionally, in a wind turbine according to an exemplary embodiment, a Reynolds number of less than 4 million may thus also be present, where appropriate, in the vicinity of a tip of the at least one rotor blade.

In addition or alternatively, a wind turbine according to an exemplary embodiment can be arranged in a wind farm comprising at least two turbines, of which at least one is a wind turbine in a wake with a reduced, dimensionless spacing based on the rotor diameter. The utilisation of space for turbine locations within a wind farm can thus be improved, where appropriate, compared to a configuration with conventional turbines.

A wind farm according to an exemplary embodiment comprises a plurality of wind turbines, that is to say at least two wind turbines, wherein at least one wind turbine comprises a horizontal axis and at least one rotor blade, wherein at least one wind turbine of the plurality of wind turbines in regular operation at a wind speed of more than 4 m/s always comprises a static thrust coefficient with a value less than 0.8 and is designed, for a design turbulence intensity according to the definition of the characteristic value of turbulence intensity at 15 m/s according to IEC 61400-1, Edition 2, of more than 18% and less than 26%.

Optionally, in a wind farm according to an exemplary embodiment, the wind turbines of the plurality of wind turbines may, in accordance with an exemplary embodiment, be arranged in a wind farm configuration. For example, all wind turbines of the plurality of wind turbines may thus be wind turbines according to an exemplary embodiment. In other words, a wind farm in accordance with an exemplary embodiment may comprise a plurality of wind turbines according to an exemplary embodiment that are arranged in a wind farm configuration.

Optionally, in a wind farm according to an exemplary embodiment, the wind turbines of the plurality of wind turbines can be arranged along a primary wind direction and along a secondary wind direction. It may thus be possible, where appropriate, to ensure that the incident flow of wind onto the individual wind turbines is more efficient.

Optionally, the wind turbines of the plurality of wind turbines in accordance with an exemplary embodiment can be arranged in a substantially right-angled wind farm configuration. Optionally, in a wind farm according to an exemplary embodiment, the plurality of wind turbines may comprise twenty wind turbines for example to mention just one of many possible exemplary embodiments. Where appropriate, it may thus be possible additionally or alternatively in a wind farm according to an exemplary embodiment to arrange the plurality of wind turbines such that they comprise a reduced, dimensionless distance based on the rotor diameter.

A method according to an exemplary embodiment for generating power comprises a generation of power by means of a wind turbine and a generation of power by means of at least one further wind turbine, wherein the at least further wind turbine is arranged in a wake of the wind turbine at a reduced, dimensionless distance based on the rotor diameter. The wind turbine comprises a horizontal axis and at least one rotor blade, wherein the wind turbine in regular operation at a wind speed of more than 4 m/s always comprises a static thrust coefficient c_{S} of less than c_{S}=0.8 and is designed for or comprises a design turbulence intensity, corresponding to the definition of the characteristic value of turbulence intensity I₁₅ at 15 m/s according to IEC 61400-1, Edition 2, of more than 18% and less than 26%.

Optionally, in a method according to an exemplary embodiment, the at least one further wind turbine may thus comprise a horizontal axis and at least one rotor blade, wherein the at least one further wind turbine in regular operation at a wind speed of more than 4 m/s always comprises a static thrust coefficient c_{S} of less than c_{S}=0.8 and the at least one further wind turbine is designed for a design turbulence intensity, corresponding to the definition of the characteristic value of turbulence intensity I₁₅ at 15 m/s according to IEC 61400-1, Edition 2, of more than 18% and less than 26%. In other words, the at least one further wind turbine may also be a wind turbine according to an exemplary embodiment.

In addition or alternatively, in a method according to an exemplary embodiment, the rotor profile of the rotor blade of the wind turbine at a design point, characterised by a maximum lift/drag ratio, in the outer region of the rotor blade may not exceed a lift coefficient of c_{A}=1.3 and a drag coefficient of c_{W}=0.01, wherein this profile may comprise an angle of attack range of more than 5°, in which the drag coefficient does not exceed the value of the minimum drag coefficient of c_{W}≦0.007 by 50%. In addition or alternatively, a blade tip speed of 71.5 m/s may optionally not be exceeded in an entire operating range. In addition or alternatively, the design tip speed ratio may also optionally be at least 6.5, but less than 8.5.

In an exemplary embodiment of a method, the above-mentioned method steps can be carried out in the stated order, but also in a deviating order where appropriate. Individual method steps can thus be carried out simultaneously where appropriate, but also at least in a chronologically overlapping manner unless otherwise evident from the description thereof or the technical context.

As has already been mentioned previously, the outer region of the rotor blade may here for example be a region of the rotor blade that, starting from the blade tip, comprises at least ⅙, at most ⅓, of the total rotor blade length, that is to say the length of the rotor blade.

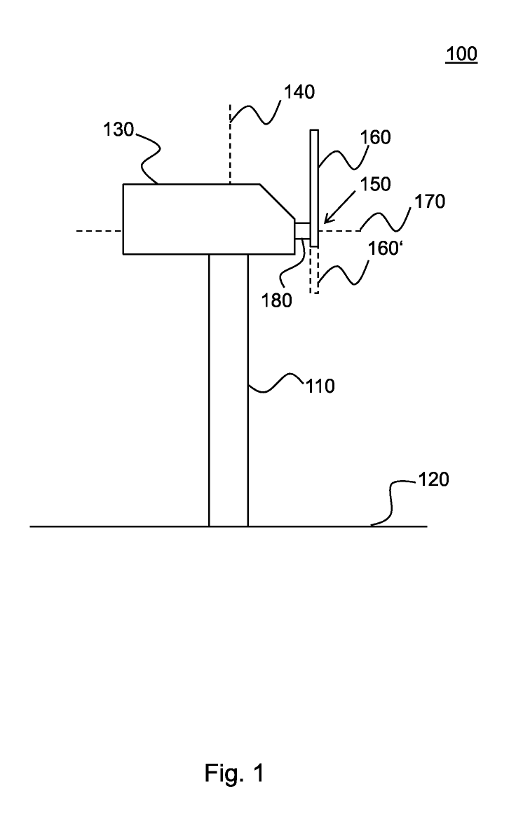

FIG. 1 shows a schematic side view of a wind turbine 100 according to an exemplary embodiment that comprises a tower 110 which is fastened indirectly or directly on or in a substrate 120. On a side of the tower 110 facing away from the substrate 120, the wind turbine 100 further comprises a nacelle 130, which for example can be pivotable about a vertical axis 140 relative to the tower 110.

The wind turbine 100 further comprises a hub 150, on which at least one rotor blade 160 is fastened. In the case of the wind turbine 100 illustrated in FIG. 1, a further rotor blade 160′ is illustrated in a dashed manner in order to illustrate the option that more than one rotor blade 160 can also be connected to the hub 150.

The rotor blade(s) 160 is/are connected to the hub 150, in this case typically rotatably, such that the individual rotor blades 160 are rotatable relative to the hub 150, for example in order to enable an adaptation of the angle of attack of the rotor blade(s) 160 to the prevailing flow conditions.

The hub 150 is in this case mounted rotatably about a horizontal axis 170 relative to the nacelle 130. The wind turbine 100 further comprises a generator (not shown in FIG. 1), which is coupled to a main shaft 180, to which the hub 150 is also coupled.

In this case, a coupling is to be understood to mean an indirect or direct mechanical connection, with which two objects are therefore mechanically coupled to one another either directly or with the aid with one or more further components. Such a coupling may comprise a coupling fixed against rotation for example, which optionally allows or also does not allow an axial displacement.

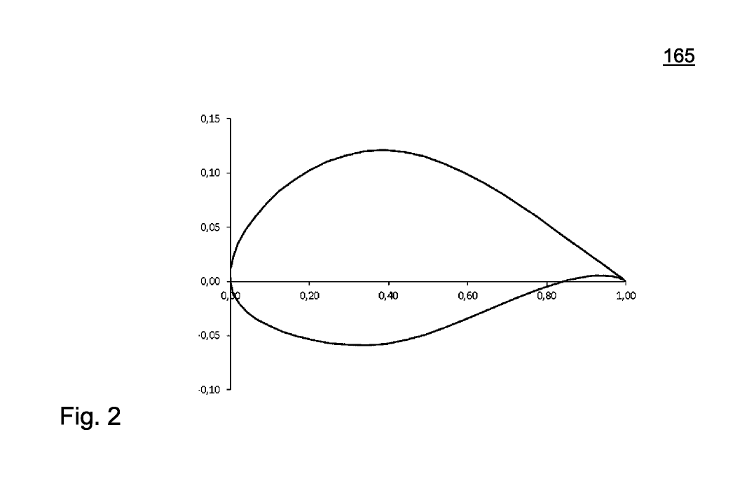

FIG. 2 shows a cross-sectional illustration through a rotor blade 160 in a standardised illustration, in which a profile 165 of the rotor blade 160 is standardised over its length. The rotor blade 160 shown in FIG. 2 can thus be used for example within the scope of a wind turbine 100 as is shown in FIG. 1.

The profile 165 shown in FIG. 2 for example thus comprises a profile thickness of 18%, a position of maximum thickness of 40%, a camber of 3.3%, and a position of maximum camber of 50%.

In FIG. 1, an exemplary embodiment of a wind turbine 100 having a horizontal axis 170 and at least one rotor blade 160 is thus shown and is characterised in that the wind turbine 100 in regular operation at a wind speed of more than 4 m/s always has a static thrust coefficient c_{S} with a value less than c_{S}=0.8 and the wind turbine 100 is designed for a design turbulence intensity, according to the definition of the characteristic value of turbulence intensity I₁₅ at 15 m/s according to IEC 61400-1, Edition 2, of more than 18% and less than 26%. In other words, the wind turbine 100 comprises a horizontal axis 170 and at least one rotor blade 160 mounted rotatably about the horizontal axis 170, wherein the wind turbine 100 in regular operation at a wind speed of more than 4 m/s always comprises a static thrust coefficient c_{S} with a value less than 0.8. Here, the wind turbine 100 is formed such that the wind turbine 100 comprises a design turbulence intensity, corresponding to the definition of the characteristic value of turbulence intensity I₁₅ at 15 m/s according to IEC 61400-1, Edition 2, of more than 18% and less than 26%.

The wind turbine shown here further comprises a further optional embodiment. The wind turbine 100 is thus characterised in that the rotor profile 165 of the rotor blade 160 of the wind turbine 100 at the design point, characterised by a maximum lift/drag ratio, in the outer region of the rotor blade additionally does not exceed a lift coefficient of c_{A}=1.3 and a drag coefficient of c_{W}=0.01, wherein this profile 165 comprises an angle of attack range of more than 5°, in which the drag coefficient does not exceed the value of the minimum drag coefficient of c_{W}≦0.007 by 50% and/or a blade tip speed of 71.5 m/s is not exceeded and/or the design tip speed ratio is at least 6.5, but less than 8.5. The design with regard to the blade tip speed can be valid in this case for the entire operating range. In other words, in the case of the wind turbine 100, the at least one rotor blade 160 comprises a rotor profile 165 that, at a design point, given by a maximum lift/drag ratio, in an outer region of the rotor blade 160, does not exceed a lift coefficient c_{A} of 1.3 and a drag coefficient c_{W} of 0.01, wherein the rotor profile 165 comprises an angle of attack range of more than 5°, in which the drag coefficient c_{W} does not exceed the value of a minimum drag coefficient of c_{W}, min≦0.007 by 50%, and/or a blade tip speed of 71.5 m/s is not exceeded, and/or the design tip speed ratio is at least 6.5, but less than 8.5.

The wind turbine shown in FIG. 1, as will be explained hereinafter, may have a further optional embodiment. The wind turbine 100 is thus characterised in that the wind turbine 100 is arranged in a wind farm comprising at least 2 turbines, at least one of which is a wind turbine in the wake at reduced, dimensionless distance based on the rotor diameter, wherein the utilisation of space for turbine locations within the wind farm is improved compared to a configuration with conventional turbines. In other words, the wind turbine is arranged in a wind farm comprising at least two turbines, at least one of which is a wind turbine in a wake at a reduced, dimensionless distance based on the rotor diameter. A utilisation of space for turbine locations within the wind farm can thus be improved, where appropriate, compared to a configuration with conventional turbines.

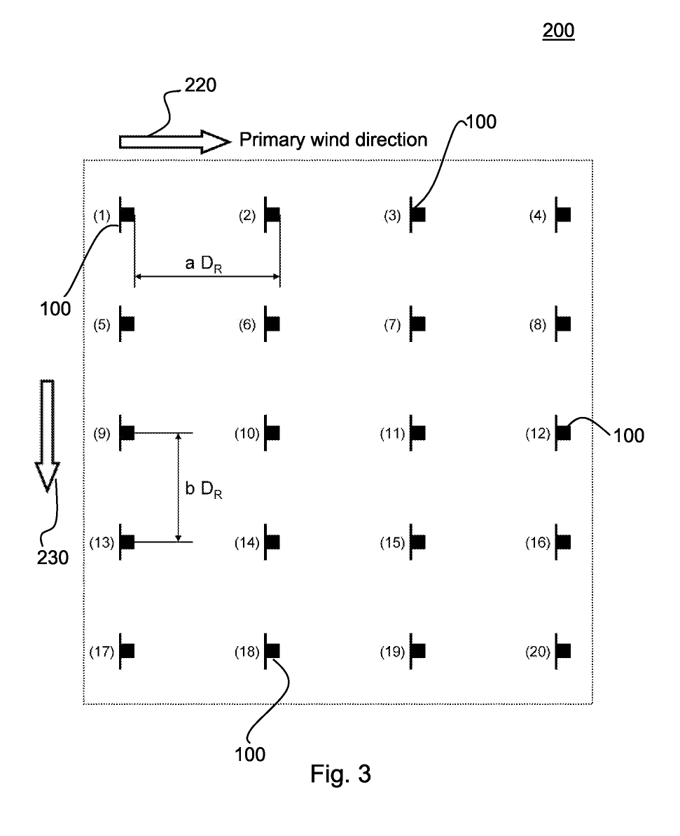

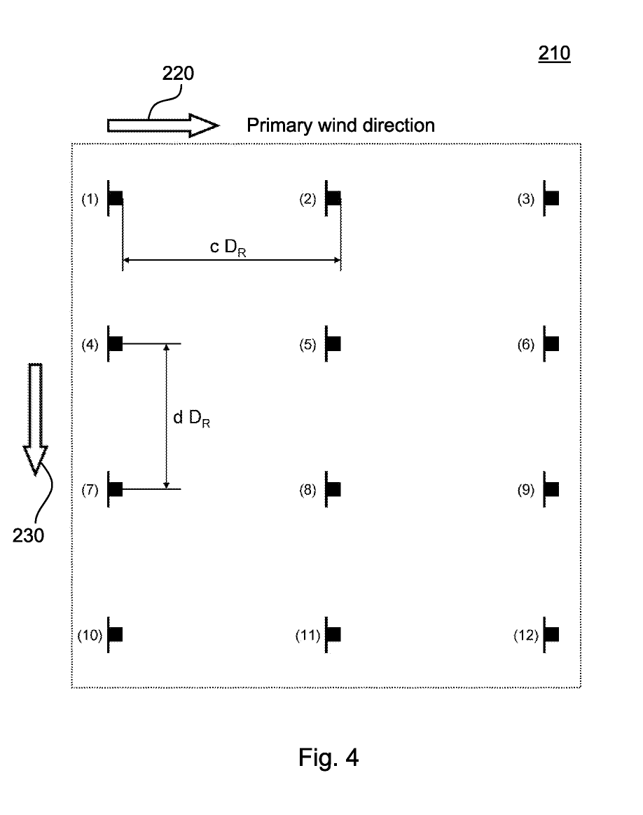

An exemplary embodiment will now be explained in greater detail with reference to FIG. 3, wherein a wind farm configuration of a wind farm 200 according to an exemplary embodiment with wind turbines 100 according to exemplary embodiments with distances of a times the rotor diameter D_{R} in a primary wind direction 220 and with distances b times the rotor diameter D_{R} in a secondary wind direction 230 is illustrated by way of example in FIG. 3. In contrast hereto, FIG. 4 shows a conventional wind farm configuration with distances c times the rotor diameter D_{R} in the main wind direction 220 and with distances d times the rotor diameter D_{R} in the secondary wind direction 230. In this case, a<c and/or b<d, wherein a, b, c and d can be positive real numbers.

To simplify the illustration, not all wind turbines 100 are denoted by a corresponding reference sign in FIG. 3. As is also shown in FIG. 3, in the exemplary embodiment shown therein of a wind farm 200, the wind turbines 100 are arranged substantially at right angles such that the configuration of the wind farm 200 is substantially right-angled. More specifically, FIG. 3 shows a wind farm 200 according to an exemplary embodiment, which comprises 20 wind turbines 100 according to an exemplary embodiment. The conventional wind farm shown in FIG. 4 by contrast comprises just 12 conventional wind turbines.

Due to the selection of a suitable profile geometry in particular in the outer region of the rotor blade, with an angle of incidence of 0°, a drag coefficient of c_{W}=0.005 and a lift coefficient of c_{A}=0.5 are achieved, wherein a maximum lift/drag ratio of E>150 is achieved. The specifications concerning the profile 165 relate to a clean state.

The wind turbine 100 (WEA) is furthermore designed such that a tip speed ratio of λ=8 and a maximum blade tip speed of approximately vₜᵢₚ=71 m/s are selected. If a rotor diameter of 115 m is selected, this results in a nominal rotor speed of approximately 11.8 revolutions per minute with a design wind speed of 8.75 m/s.

Due to the selection of the aforementioned operating conditions and design parameters, a static thrust coefficient of c_{S}=0.752 is produced if the wind speed corresponds to the design wind speed.

The positive influencing of the wake with such a wind turbine in accordance with an exemplary embodiment leads, or can lead, to lower turbulences of the wake flow, wherein, with suitable selection of the blade depth, a Reynolds number of less than 4 million is produced in the vicinity of the blade tip.

With the wind turbine 100 according to an exemplary embodiment, a reduction of the sound emissions compared to conventional technology is, or can be, achieved, where appropriate.

The wind turbine according to an exemplary embodiment additionally comprises, or may comprise, due to the material selection, the selection of the production methods and the dimensioning of the components, a greater strength and rigidity, such that a higher design turbulence intensity of more than 18%, but no more than 26% is produced, instead of 16% to 18%, as with conventional wind turbines, corresponding to the definition of the characteristic value of turbulence intensity I₁₅ at 15 m/s according to IEC 61400-1, Edition 2.

The wind turbine 100 according to an exemplary embodiment also comprises, or may comprise, a design turbulence intensity of more than 16% instead of 12 to 16% as with conventional wind turbines, corresponding to the definition of the expected value of turbulence intensity I_{ref} at 15 m/s according to IEC 61400-1, Edition 3.

The combination of optimised rotor profiles, the limitation of blade tip speed and tip speed ratio, and also the consideration of a higher design turbulence intensity thus enables, or may enable, in the case of wind turbines in the wake, a reduction of the distance from turbines arranged in front. With the wind turbine according to an exemplary embodiment, an improvement of the utilisation of space of the wind farm can be achieved or is achieved, where appropriate.

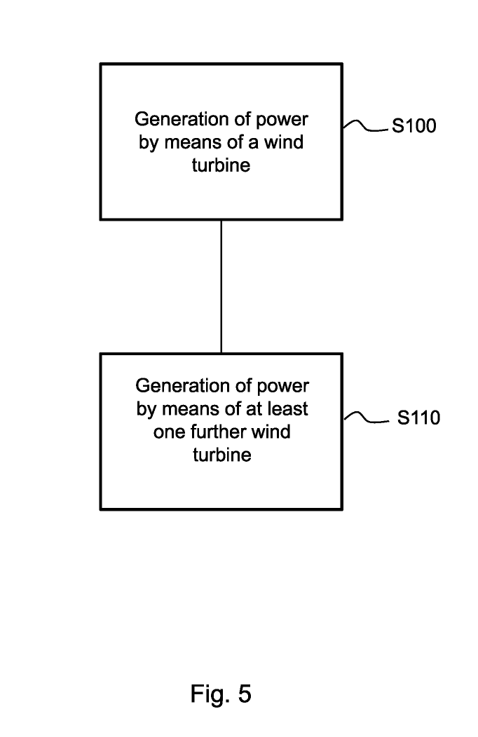

FIG. 5 lastly shows a flow diagram of a method for generating power according to an exemplary embodiment. The method for generating power thus comprises a generation S100 of power by means of a wind turbine 100 according to an exemplary embodiment and a generation S110 of power by means of at least one further wind turbine. The at least one further wind turbine may optionally be a wind turbine that constitutes an exemplary embodiment. The generation of power S100 is also referred to as a first generation S100, and the generation of power S110 is also referred to as a second generation S110. These processes can take place chronologically sequentially in part or completely, but also simultaneously or in a chronologically overlapping manner. Optionally, a method according to an exemplary embodiment may also comprise a uniting of the generated powers and/or a delivery of the combined power or the generated powers. In this case, the power may of course be electrical power.

Of course, the generation of power is to be understood within the meaning of a conversion of one form of power to another. The expression “generation of power” is therefore to be understood within the meaning of a recovery of technically more easily exploitable power or forms of power, that is to say within the context of a recovery, conversion or generation of electrical power with the aid of a wind turbine.

The at least one further wind turbine is arranged in this case in a wake of the wind turbine 100 according to an exemplary embodiment at a reduced, dimensionless distance based on the rotor diameter. The wind turbine 100 according to an exemplary embodiment thus also here again comprises a horizontal axis 170 and at least one rotor blade 160, wherein the wind turbine 100 in regular operation at a wind speed of more than 4 m/s always comprises a static thrust coefficient c_{S} of less than c_{S}=0.8 and the wind turbine 100 is designed for a design turbulence intensity, corresponding to the definition of the characteristic value of turbulence intensity I₁₅ at 15 m/s according to IEC 61400-1, Edition 2, of more than 18% and less than 26%.

The at least one further wind turbine may likewise optionally be a wind turbine according to an exemplary embodiment. In such a case, the at least one further wind turbine likewise comprises a horizontal axis 170 and at least one rotor blade 160, wherein the at least one further wind turbine in regular operation at a wind speed of more than 4 m/s always comprises a static thrust coefficient c_{S} less than c_{S}=0.8 and the at least one further wind turbine is designed for a design turbulence intensity, corresponding to the definition of the characteristic value of turbulence intensity I₁₅ at 15 m/s according to IEC 61400-1, Edition 2, of more than 18% and less than 26%.

In addition or alternatively, the rotor profile 165 of the rotor blade 160 of the wind turbine 100 at the design point, characterised by a maximum lift/drag ratio, in the outer region of the rotor blade in this case may additionally not exceed a lift coefficient of c_{A}=1.3 and a drag coefficient of c_{W}=0.01. This profile 165 may have an angle of attack range of more than 5°, in which the drag coefficient does not exceed the value of the minimum drag coefficient of c_{W}≦0.007 by 50%, and/or a blade tip speed of 71.5 m/s is not exceeded in an entire operating range, and/or the design tip speed ratio is at least 6.5, but less than 8.5.

Exemplary embodiments thus concern, inter alia, a wind turbine 100 which, arranged in wind farms 200, leads or can lead to an improved utilisation of space.

In other words, exemplary embodiments concern a wind turbine 100 having a horizontal axis 170 and at least one rotor blade 160, which, arranged in wind farms 200, can lead to an improved utilisation of space. For such a wind turbine 100, the design tip speed ratio is reduced compared to conventional wind turbines and a lower blade tip speed is selected. In addition, the wind turbine comprises a static thrust coefficient c_{S} of less than 0.8 and also at the design point in the outer region of the rotor a blade profile 165 having a lift coefficient c_{A} of less than 1.3 and a drag coefficient c_{W} of less than 0.01. Here, the value of the minimum drag coefficient of at most 0.007 in an angle of attack range of more than 5° is not exceeded by more than 50%. In addition, such a wind turbine is designed for a design turbulence intensity of more than 18% and less than 26%. The wind turbine can be arranged in a wind farm 200 comprising at least 2 turbines, at least one of which is a wind turbine in the wake at a reduced, dimensionless distance based on the rotor diameter, wherein the utilisation of space of such a configuration is thus improved.

The features disclosed in the description above, the claims hereinafter and the accompanying figures can be of significance and implemented both individually and in any combination for the realisation of an exemplary embodiment in its various forms.

Although some aspects have been described in conjunction with a device, it is understood that these features may also constitute a description of the corresponding method, such that a block or a structural element of a device is also to be understood as a corresponding method step or as a feature of a method step. Similarly, aspects that have been described in conjunction with a method step or as a method step also constitute as a description of a corresponding block or detail or feature of a corresponding device.

The above-described exemplary embodiments merely illustrate the principles of the present invention. It is understood that modifications and variations of the arrangements and details described herein will be obvious to other individuals skilled in the art. The invention is therefore intended to be limited merely by the scope of protection of the following patent claims, and not by the specific details that have been presented herein on the basis of the description and the explanation of the exemplary embodiments.

1. A wind turbine, comprising a horizontal axis and at least one rotor blade, wherein the wind turbine in regular operation at a wind speed of more than 4 m/s always comprises a static thrust coefficient with a value less than 0.8, and wherein the wind turbine is designed for a design turbulence intensity, corresponding to the definition of the characteristic value of turbulence intensity at 15 m/s according to IEC 61400-1, Edition 2, of more than 18% and less than 26%.

2. The wind turbine according to claim 1, in which the rotor profile of the rotor blade of the wind turbine at a design point, given by a maximum lift/drag ratio, in an outer region of the rotor blade additionally does not exceed a lift coefficient of 1.3 and a drag coefficient of 0.01, wherein this profile comprises an angle of attack range of more than 5°, in which at least one of the following conditions is met:
the drag coefficient does not exceed the value of the minimum drag coefficient of at most 0.007 by 50%;
a blade tip speed of 71.5 m/s is not exceeded; and
a design tip speed ratio is at least 6.5, but less than 8.5.

3. The wind turbine according to claim 2, wherein the wind turbine is arranged in a wind farm comprising at least two turbines, at least one of which is a wind turbine arranged in the wake at a reduced, dimensionless distance based on the rotor diameter, wherein the utilisation of space for turbine locations within the wind farm is improved compared to a configuration with conventional turbines.

4. The wind turbine according to claim 1, in which the at least one rotor blade in an outer region at an angle of incidence of 0° comprises a drag coefficient of 0.005 and a lift coefficient of 0.5, wherein, in a clean state, a maximum lift/drag ratio of more than 150 is achieved.

5. The wind turbine according to claim 1, which is designed such that it comprises a tip speed ratio of 8, a maximum blade tip speed of 71 m/s, and a thrust coefficient of 0.752.

6. The wind turbine according to claim 5, which comprises a rotor diameter of 115 m and a design wind speed of 8.75 m/s.

7. A wind farm, comprising:
a plurality of wind turbines,
wherein at least one wind turbine comprises a horizontal axis and at least one rotor blade,
wherein at least one wind turbine in regular operation at a wind speed of more than 4 m/s always comprises a static thrust coefficient with a value less than 0.8 and is designed for a design turbulence intensity, corresponding to the definition of the characteristic value of turbulence intensity at 15 m/s according to IEC 61400-1, Edition 2, of more than 18% and less than 26%.

8. The wind farm according to claim 7, in which the wind turbines of the plurality of wind turbines are arranged in a wind farm configuration and comprise a horizontal axis and at least one rotor blade, wherein the wind turbines of the plurality of wind turbines in regular operation at a wind speed of more than 4 m/s always comprise a static thrust coefficient with a value less than 0.8 and are designed for a design turbulence intensity, corresponding to the definition of the characteristic value of turbulence intensity at 15 m/s according to IEC 61400-1, Edition 2, of more than 18% and less than 26%.

9. The wind farm according to claim 8, in which the wind turbines of the plurality of wind turbines are arranged along a primary wind direction and along a secondary wind direction.

10. The wind farm according to claim 9, in which the wind turbines of the plurality of wind turbines are arranged in a right-angled wind farm configuration.

11. The wind farm according to claim 8, in which the wind turbines of the plurality of wind turbines comprise a reduced, dimensionless distance based on the rotor diameter.

12. A method for generating power, comprising:
a generation of power by means of a wind turbine; and
a generation of power by means of at least one further wind turbine,
wherein the at least one further wind turbine is arranged in a wake of the wind turbine at a reduced, dimensionless distance based on the rotor diameter;
wherein the wind turbine comprises a horizontal axis and at least one rotor blade; and
wherein the wind turbine in regular operation at a wind speed of more than 4 m/s always comprises a static thrust coefficient less than 0.8 and is designed for a design turbulence intensity, corresponding to the definition of the characteristic value of turbulence intensity at 15 m/s according to IEC 61400-1, Edition 2, of more than 18% and less than 26%.

13. The method according to claim 12, in which the at least one further wind turbine comprises a horizontal axis and at least one rotor blade, and wherein the at least one further wind turbine in regular operation at a wind speed of more than 4 m/s always comprises a static thrust coefficient less than 0.8 and the at least one further wind turbine is designed for a design turbulence intensity corresponding to the definition of the characteristic value of turbulence intensity at 15 m/s according to IEC 61400-1, Edition 2, of more than 18% and less than 26%.

14. The method according to claim 12, in which the rotor profile of the rotor blade of the wind turbine at a design point, characterised by a maximum lift/drag ratio, in the outer region of the rotor blade additionally does not exceed a lift coefficient of 1.3 and a drag coefficient of 0.01, wherein this profile comprises an angle of attack range of more than 5°, in which at least one of the following conditions is met:
the drag coefficient does not exceed the value of the minimum drag coefficient of at most 0.007 by 50%;
a blade tip speed of 71.5 m/s is not exceeded in an entire operating range; and
the design tip speed ratio is at least 6.5, but less than 8.5.
